(19) United States
(12) Patent Application Publication
(10) Pub. No.: US 2010/0181280 A1
(43) Pub. Date: Jul. 22, 2010

(54) Round and Four Sided Container

(75) Inventors: Justin A. Howell, New Cumberland, PA (US); Gregory A. Trude, Seven Valleys, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: GRAHAM PACKAGING COMPANY, L.P., York, PA (US)

(21) Appl. No.: 12/358,139

(22) Filed: Jan. 22, 2009

(51) Int. Cl. B65D 90/02; B23P 17/00

(52) U.S. Cl. 215/370; 29/592

(57) ABSTRACT

A container having side vacuum panels that can have a substantially planar surface. The front and rear panels are rounded and can be used in order to accommodate. Only the side panels flex in order to accommodate the hot-fill process. The panels accommodate the placement of labels or provision of embossment.

### BACKGROUND OF THE INVENTION

1. Field of the Invention

The present invention is related to the field of containers. In particular the present invention is related to hot fill containers.

2. Description of the Related Technology

In the past, containers used for the storage of products, such as beverages, were made of glass. Glass was used due to its transparency, its ability to maintain its structure and the ease of affixing labels to it. However, glass is fragile and heavy. This results in lost profits due to broken containers during shipping and storage caused by the usage of glass and additional costs due to the transportation of heavier materials.

Plastic containers are used more frequently today due to their durability and lightweight nature. Polyethylene terephthalate (PET) is used to construct many of today's containers. PET containers are lightweight, inexpensive, recyclable and manufacturable in large quantities.

PET containers are often used for products, such as beverages. Often these liquid products, such as juices and isotonics, are filled into the containers while the liquid product is at an elevated temperature, typically between 68° C.-96° C. (155° F.-205° F.) and usually about 85° C. (185° F.). When packaged in this manner, the hot temperature of the liquid is used to sterilize the container at the time of filling. This process is known as hot-filling. The containers that are designed to withstand the process are known as hot-fill containers.

The use of blow molded plastic containers for packaging hot-fill beverages is well known. However, a container that is used in the hot-fill process is subject to additional stresses on the container that can result in the container failing during storage or handling or to be deformed in some manner. The sidewalls of the container can become deformed and/or collapse as the container is being filled with hot fluids. The rigidity of the container can decrease after the hot-fill liquid is introduced into the container.

Some products have in the past typically used glass jars due to the nature of the product. However, as discussed above glass containers are problematic due to the chance of breakage and heavier weight. Switching to existing types of plastic containers can prove to be an unappealing option requiring the alteration to existing fill lines, Furthermore, the new type of container may be aesthetically undesirable. Therefore there is need in the field to create a container made of plastic that can utilize existing fill lines and remain aesthetically desirable.

### SUMMARY OF THE INVENTION

An object of the invention is a hot fillable container for storing food.

Yet another object of the invention is method for making a hot fillable container for storing food.

Still yet another object of the invention is the provision of a hot fillable container capable of using existing fill lines.

A container comprising: a threaded neck portion for accommodating a lid; a rounded shoulder portion for accommodating existing fill lines; a body portion comprising four panels, wherein at least two of the four panels are rounded surfaces; and a rounded bottom portion for accommodating existing fill lines.

A method for making a container comprising forming a container, wherein the container comprises; a threaded neck portion for accommodating a lid; a rounded shoulder portion for accommodating existing fill lines; a body portion comprising four panels, wherein at least two of the four panels are rounded surfaces; and a rounded bottom portion for accommodating existing fill lines; and hot-filling the container.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 shows a side view of the container in accordance with the present invention.

FIG. 2 shows an isometric view of the container shown in FIG. 1.

FIG. 3 shows an isometric view of the container shown in FIG. 1.

FIG. 4 shows a front view of the container shown in FIG. 1.

FIG. 5 shows a rear view of the container shown in FIG. 1.

FIG. 6 shows a top view of the container shown in FIG. 1.

FIG. 7 shows a bottom view of the container shown in FIG. 1.

FIG. 8 shows a cross-sectional view of the container shown in FIG. 1.

FIG. 9 shows a front view of an alternative embodiment of the container in accordance with the present invention.

FIG. 10 shows a bottom view of the container shown in FIG. 9.

FIG. 11 shows a top view of the container shown in FIG. 9.

FIG. 12 is a cross sectional view of the container shown in FIG. 9.

FIG. 13 shows a flow chart of the method for providing a hot-fillable container.

### DETAILED DESCRIPTION OF THE PREFERRED EMBODIMENT(S)

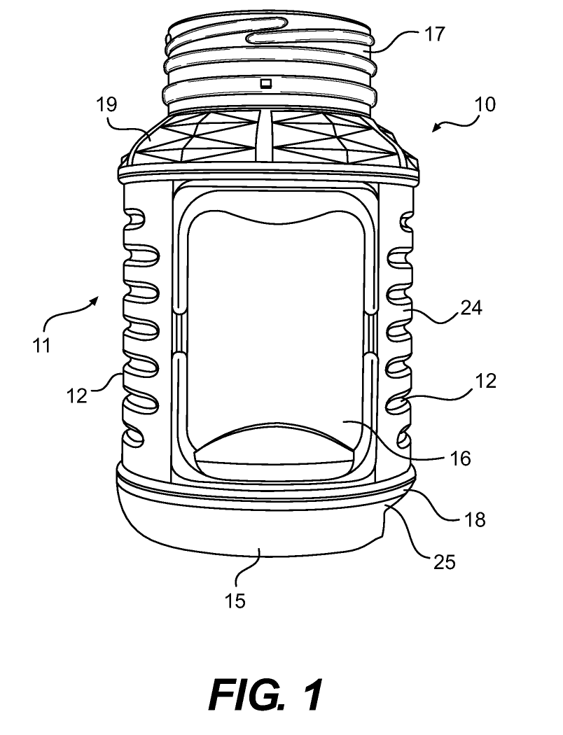

Referring now to the drawings, wherein like reference numerals designate corresponding structure throughout the views, and referring in particular to FIG. 1, a container 10 is shown that can typically be the size of a jar. The container 10 can be used for any food or liquid that requires usage of a hot-fill process, this can include such food items as salsa, dips, fruits, etc.

The container 10 may be constructed using those methods and materials typically used in the construction of plastic containers. The container 10 may be a one-piece construction and may be prepared from a monolayer plastic material, such as a polyamide, for example, nylon; a polyolefin such as polyethylene, for example, low density polyethylene (LDPE) or high density polyethylene (HDPE), or polypropylene; a polyester, for example polyethylene terephthalate (PET), polyethylene naphthalate (PEN); or others, which may also include additives to vary the physical or chemical properties of the material. For example, some plastic resins may be modified to improve the oxygen permeability.

Alternatively, the container may be prepared from a multilayer plastic material. The layers may be any plastic material, including virgin, recycled and reground material, and may include plastics or other materials with additives to improve physical properties of the container. In addition to the above-mentioned materials, other materials often used in multilayer plastic containers include, for example, ethylvinyl alcohol (EVOH) and tie layers or binders to hold together materials that are subject to delamination when used in adjacent layers. A coating may be applied over the monolayer or multilayer material, for example to introduce oxygen barrier properties. In an exemplary embodiment, the present container is prepared from PET.

The container 10 is constructed to withstand the rigors of hot-fill processing. Container 10 may be made by conventional blow molding processes including, for example, extrusion blow molding, stretch blow molding and injection blow molding. These molding processes are discussed briefly below.

For example, with extrusion blow molding, a molten tube of thermoplastic material, or plastic parison, is extruded between a pair of open blow mold halves. The blow mold halves close about the parison and cooperate to provide a cavity into which the parison is blown to form the container. As so formed, the container 10 may include extra material, or flash, at the region where the molds come together, or extra material, or a moil, intentionally present above the container finish. After the mold halves open, the container 10 drops out and is then sent to a trimmer or cutter where any flash of moil is removed. The finished container 10 may have a visible ridge (not shown) formed where the two mold halves used to form the container came together. This ridge is often referred to as the parting line.

With stretch blow molding, for example, a pre-formed parison, or pre-form, is prepared from a thermoplastic material, typically by an injection molding process. The pre-form typically includes an opened, threaded end, which becomes the threaded member 17 of the container 10. The pre-form is positioned between two open blow mold halves. The blow mold halves close about the pre-form and cooperate to provide a cavity into which the pre-form is blown to form the container. After molding, the mold halves open to release the container 10. For wide mouth containers, the container 10 may then be sent to a trimmer where the moil, or extra plastic material above the blown finish, is removed.

With injection blow molding, a thermoplastic material may be extruded through a rod into an injection mold to form a parison. The parison is then positioned between two open blow mold halves. The blow mold halves close about the parison and cooperate to provide a cavity into which the parison may be blown to form the container 10. After molding, the mold halves open to release the container 10.

Plastic blow-molded containers, particularly those molded of PET, have been utilized in hot-fill applications where the container 10 is filled with a liquid product heated to a temperature in excess of 180° F. (i.e., 82° C.), capped immediately after filling, and then allowed to cool to ambient temperatures.

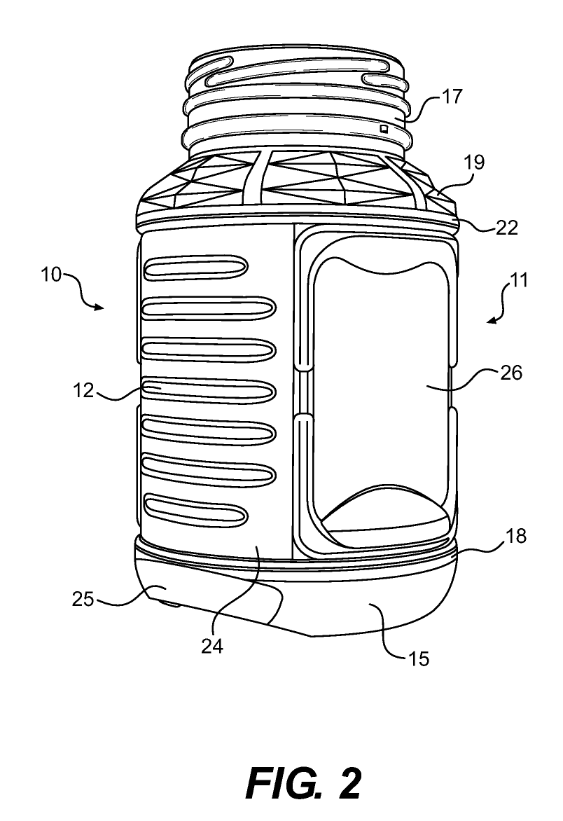

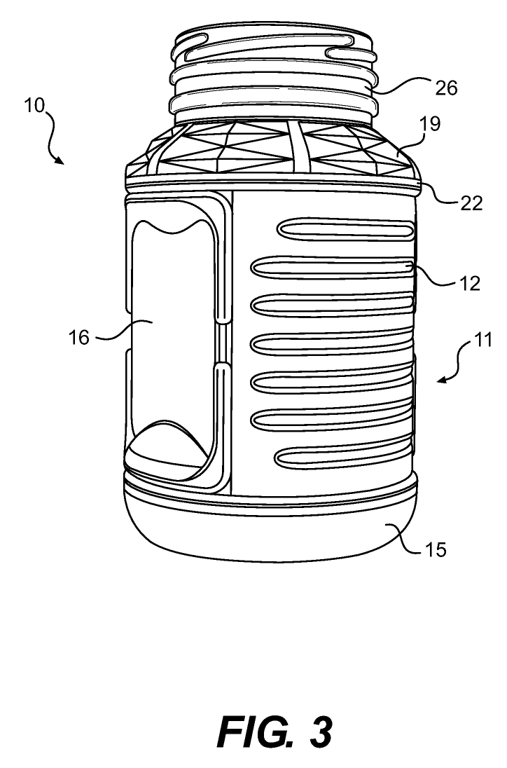

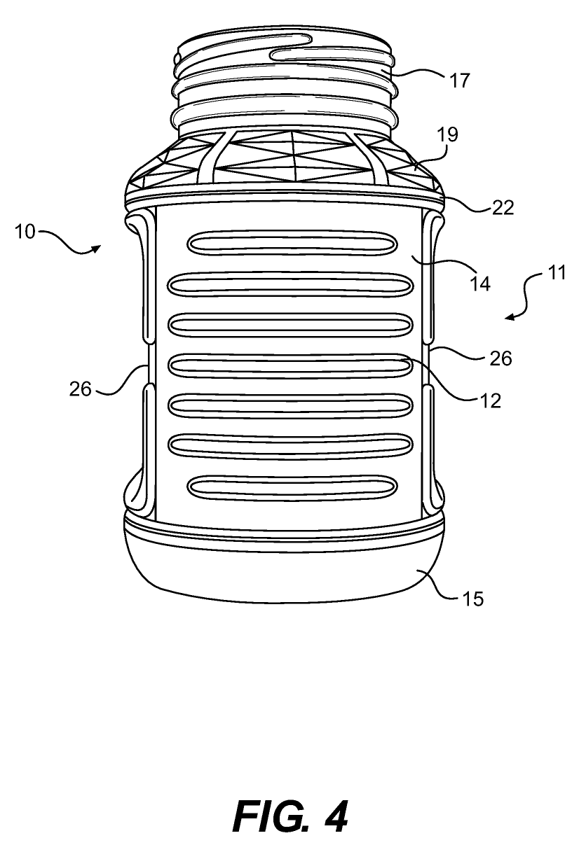

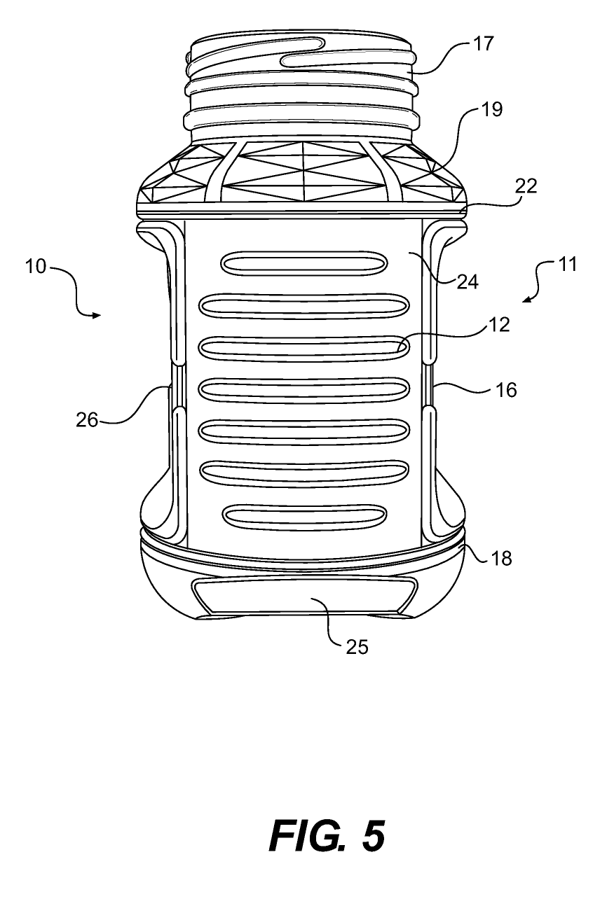

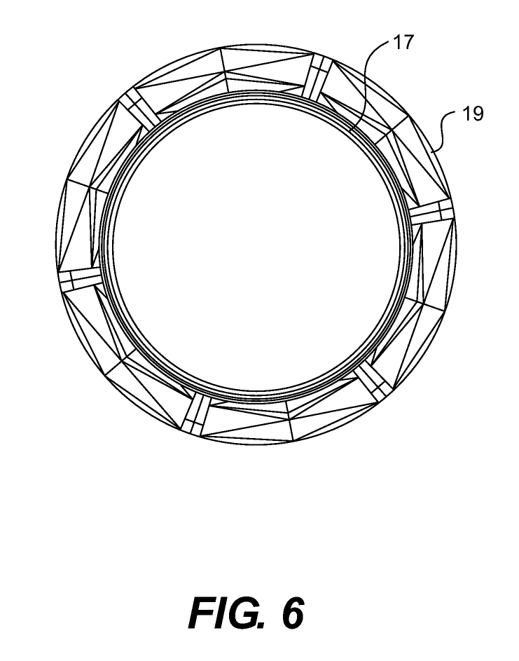

FIGS. 1-6 show the container 10 in accordance with the present invention. The container 10 has a body portion 11 that has a front panel 14 and a rear panel 24. The front panel 14 and the rear panel 24 are rounded surfaces. The front panel 14 and the rear panel 24 have ribs 12 that provide support structure for the container 10. The rounded surfaces of the front panel 14 and the rear panel 24 are able to accommodate placement of labels due to their non-deformation during the hot-fill process.

Adjacent to the front panel 14 and the rear panel 24 are side panels 16 and 26. Side flex panels 16 and 26 are flat planar vacuum panels that are able to accommodate the deformation of the container 10 that occurs during the hot-fill process. On typical square containers all four sides move due to hot fill and create compound curvature which cannot be labeled. In the container 10 shown in FIG. 1 the side flex panels 16 and 26 are the panels that are designed to accommodate this movement. The side flex panels 16 and 26 are recessed with respect to the peripheral edge 18 of the base portion 15 and the peripheral edge 22 of the shoulder portion 19. The recessed side flex panels 16 and 26 also provide locations for accommodating gripping by an individual.

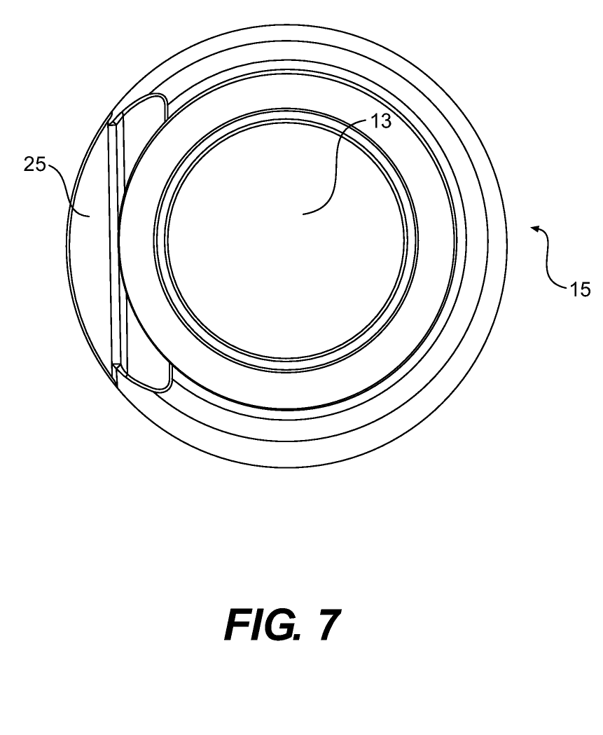

FIG. 7 is view of the base portion 15 of the container 10. The base portion 15 additionally has a step portion 25 and bottom 13 that provides additional structure for accommodating the positioning of the container 10 on hot-fill lines. Additionally the rounded shoulder portions 19 and the rounded base portion 15 are able to easily accommodate the placement of the container 10 on existing fill lines. Usage of the existing fill lines permits reduction in costs in the transition from using glass containers to using plastic containers.

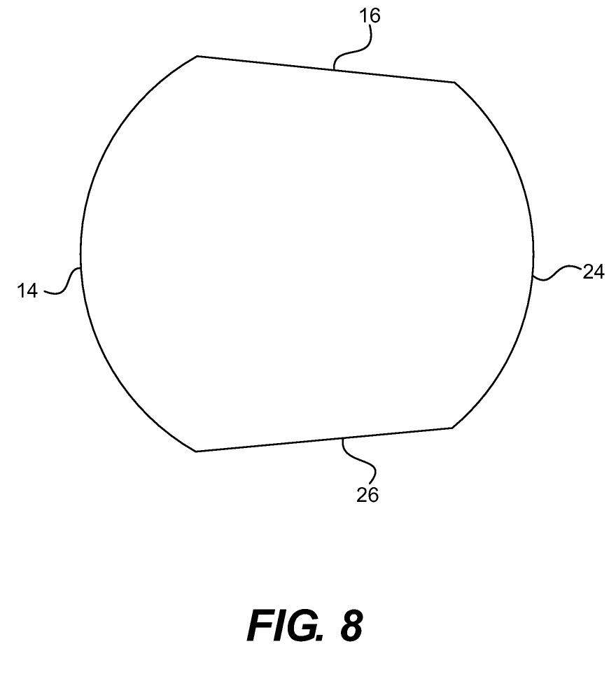

FIG. 8 shows a cross-sectional view of the container 10 shown in FIG. 1. The cross-sectional view of the container 10 shows the two flat side flex panels 16 and 26. In the embodiment shown in FIG. 8 the front panel 14 is wider than the rear panel 24. This maximizes the amount of areas that is able to be used for labeling purposes. The front panel 14 being wider than the rear panel 24 requires that the side flex panels 16 and 26 are slanted with respect to the front panel 14 and rear panel 24. The slanted nature of the side flex panels 16 and 26 mean that the side flex panels 16 and 26 are not parallel with respect to each other.

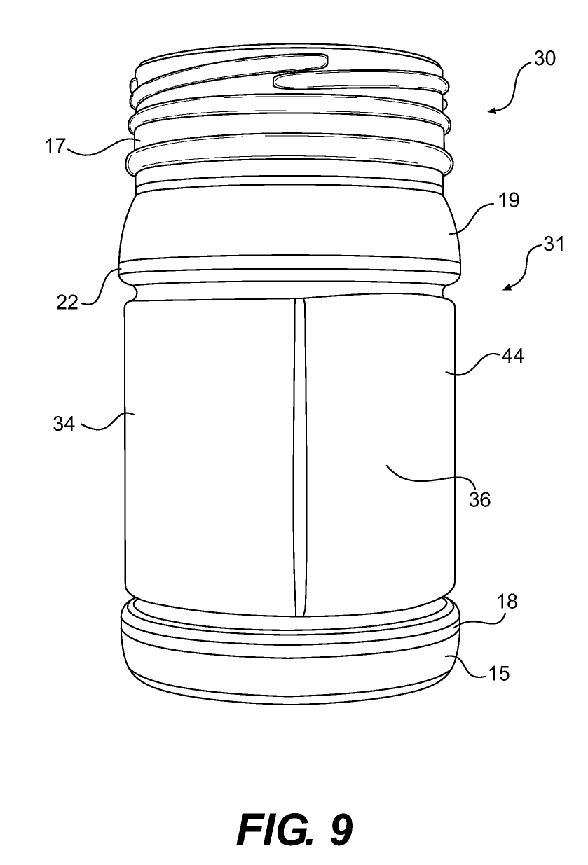

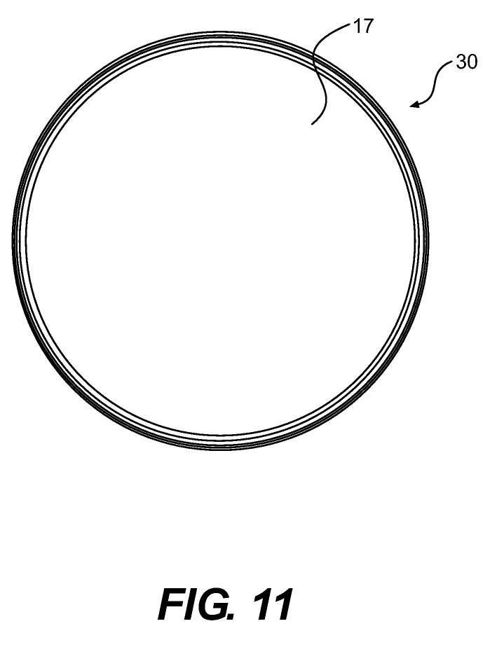

FIGS. 9-12 show a container 30, which is an alternative embodiment of the jar made in accordance with the present invention. The container 30 has a body portion 31 that has a front panel 34 and a rear panel 44. Front panel 34 and rear panel 44 are rounded surfaces that are able to accommodate the labeling of the container 30, which in this embodiment may be formed by embossment. This is due to the lack of deformation that occurs during the hot fill process.

Adjacent to the front panel 34 and the rear panel 44 are side flex panels 36 and 46. The side flex panels 36 and 46 are curved. Side flex panels 36 and 46 are designed to deform during the hot-fill process and retain an aesthetically pleasing shape after the filling of the container. Side flex panels 36 and 46 also are not contained within a ribbed framed structure unlike standard hot fill containers, which typically have a window frame around the flex panel.

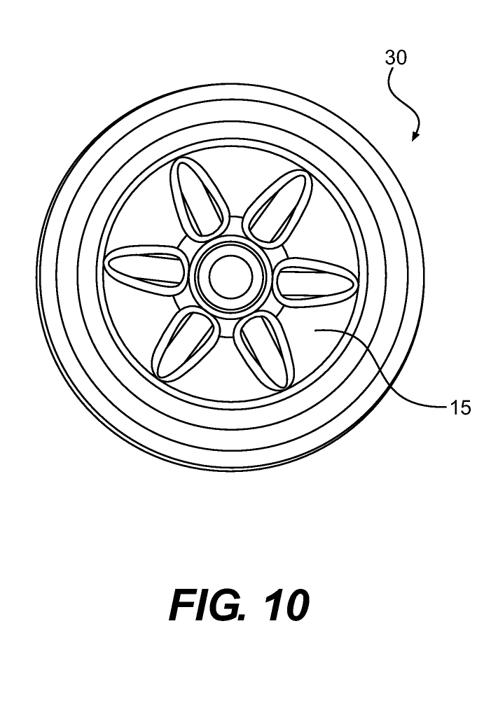

FIG. 10 is a view of the base portion 15 of the container 30. Additionally the rounded shoulder portions 19 and the rounded base portion 15 are able to easily accommodate the placement of the container 30 on existing fill lines. Usage of the existing fill lines permits reduction in costs in the transition from using glass containers to using plastic containers.

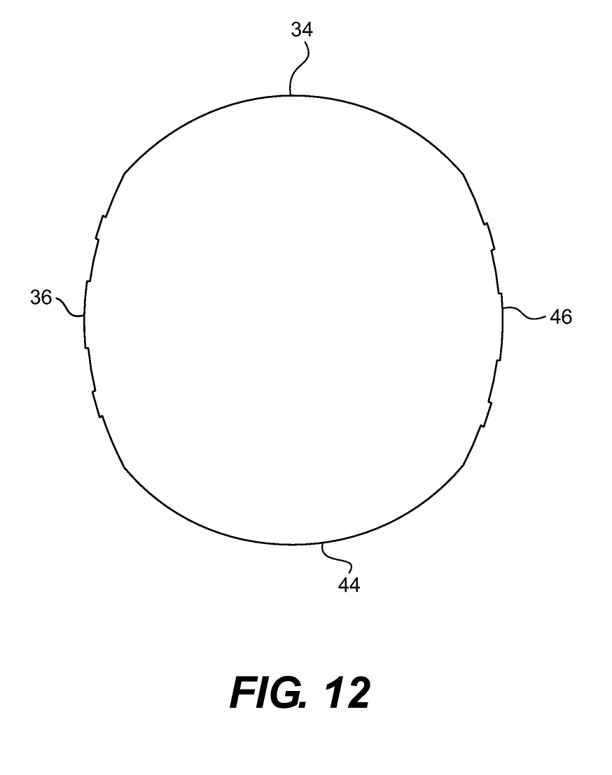

FIG. 12 shows a cross-sectional view of the container 30 shown in FIG. 9. The cross-sectional view of the container 30 shows that the flex side panels 36 and rear panel 46, while not being flat, have slightly decreased curvature than that of the front and rear panels 34 and 44. This creates a somewhat oval shape for the container 30. In the embodiment shown in FIG. 12 the width of the front panel 34 is approximately the same width of the rear panel 44.

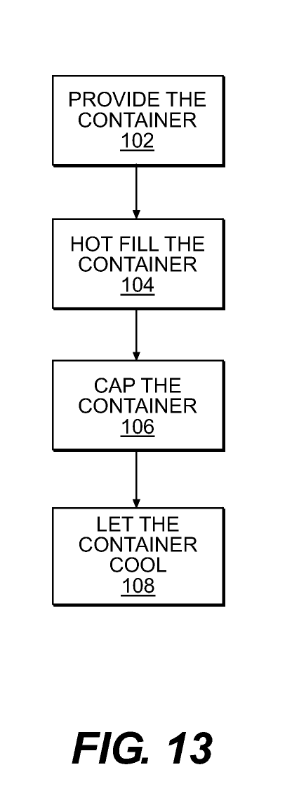

FIG. 13 shows a flow chart of the method for hot filling the container 10. The same method is applicable to each of the containers disclosed herein. In step 102, the container 10 is provided. In step 104, the container 10 is filled. In step 106, the container 10 is capped.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A hot tillable container comprising:
a threaded neck portion for accommodating a lid;
a rounded shoulder portion for accommodating existing fill lines;
a body portion comprising four panels, wherein at least two of the four panels are rounded surfaces and the rounded surfaces are adapted to be labeled; and
a rounded bottom portion for accommodating existing fill lines.

2. The container of claim 1, wherein the at least two of the four panels are not the same width.

3. The container of claim 1, wherein the at least two of the four panels are flex panels.

4. The container of claim 1, wherein the at least two of the four panels do not have ribs.

5. The container of claim 1, wherein each of the four panels are rounded surfaces.

6. The container of claim 5, wherein two of the fours panels have a decreased curvature with respect to the other two panels.

7. The container of claim 6, wherein the two of the four panels having increased curvature are used for labeling.

8. The container of claim 1, wherein the rounded bottom portion further comprises a step portion.

9. The container of claim 1, wherein at least two of the four panels are non-parallel with respect to each other.

10. A method for providing a hot-fillable container comprising:
forming a container, wherein the container comprises;
a threaded neck portion for accommodating a lid;
a rounded shoulder portion for accommodating existing fill lines;
a body portion comprising four panels, wherein at least two of the four panels are rounded surfaces and the rounded surfaces are adapted to be labeled;
and a rounded bottom portion for accommodating existing fill lines; and
hot-filling the container.

11. The method of claim 10, wherein the at least two of the four panels are not the same width.

12. The method of claim 10, wherein the at least two of the four panels are flex panels.

13. The method of claim 10, wherein the at least two of the four panels do not have ribs.

14. The method of claim 10, wherein each of the four panels are rounded surfaces.

15. The method of claim 14, wherein two of the fours panels have a decreased curvature with respect to the other two panels.

16. The method of claim 15, wherein the two of the four panels having increased curvature are used for labeling.

17. The method of claim 10, wherein the rounded bottom portion further comprises a step portion.

18. The method of claim 10, wherein at least two of the four panels are non-parallel with respect to each other.
